(19) United States
(12) Patent Application Publication
(10) Pub. No.: US 2003/0112155 A1
(43) Pub. Date: Jun. 19, 2003

(54) Method for tracking waste

(76) Inventors: Martin Landre, Bonn (DE); Silke Cebulla, Koln (DE); Thomas Staudt, Merzenich (DE); Ewald Assion, Niederkassel (DE)

Correspondence Address: Aslan Baghdadi, Shaw Pittman, 1650 Tysons Boulevard, McLean, VA, 22102, US

(21) Appl. No.: 10/276,549

(22) PCT Filed: Jun. 8, 2001
(86) PCT No.: PCT/EP01/06667

(30) Foreign Application Priority Data
Jun. 24, 2000 (DE) 100 30 905.4

(51) Int. Cl. B65F 1/14

(52) U.S. Cl. 340/988; 340/10.1

(57) ABSTRACT

Use of transponders for the documentation of waste manipulation whereby packages are generated at the collection sites, a material designation is submitted to a databank for every package, a transponder is attached to every package, a transponder identification is read into the databank and the transponder identification is allocated to the material designation, the packages are transported in transport lots, whereby a reading of the transponder occurs during loading and the read data are entered into the databank, at the waste treatment location the transponder and its package are treated and read and the treated packages are registered in the databank.

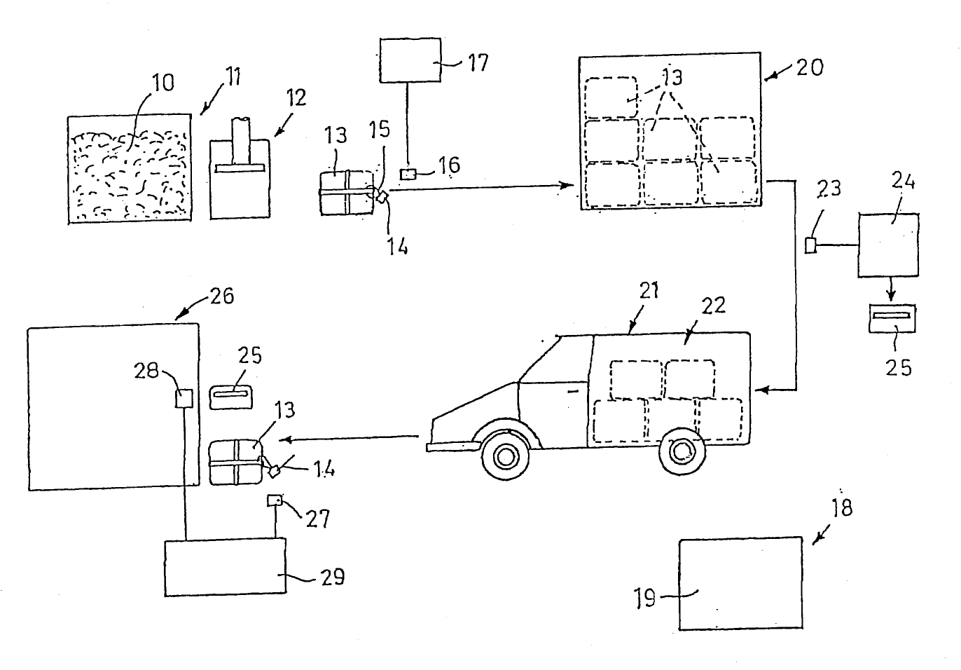

The present invention relates to the use of transponders for the documentation of waste manipulation. Furthermore, the invention can always be included in the so-called Supply-Chain Management when goods and/or services are transported via a logistics chain.

When recycling waste materials, in particular plastics, waste is combined in packages at collection sites. The packages are stored and then transported in lots, comprised of a defined number of packages, to a treatment location.

At the treatment location the waste is recycled using methods such as granulation, melting or similar treatments. It is common that producers of products that contain recycled materials receive a subsidy for the material treatment from a central institution. The central institution then has to ensure that the waste that is added to a collection site is actually transported to an authorized waste treatment location. It is thus necessary to follow and document the waste route from collection to treatment.

In the past, the documentation was achieved by issuing transport documents that would accompany the different transports. Theoretically, the transport route of wastes could be documented and traced with such transport documents. In practice though, this method poses considerable difficulties. There are cases when waste cargo was not sent to the appropriate waste treatment location but was sent abroad or was unloaded on non-licensed disposal sites. For such waste the bonuses and transport costs have then deceitfully been collected. The common transport document system is furthermore very labor intensive and susceptible to mistakes.

Processes and devices that use transponders exist for the identification, tracking or monitoring of objects. An example thereof is U.S. Pat. No. 5,910,776. In that patent it is considered a disadvantage when a transponder is attached to the object, as usually provided for, because the method often relies on the dependability of people. Furthermore, it is difficult to place the transponder in such a manner that it is not affected by interfering materials or electric fields. U.S. Pat. No. 5,910,776 finds a solution for one special use, namely for electric devices, to interrogate the transponder via a reader built into connector sockets.

However, one use of transponders for documentation of waste manipulation has not yet been thought of. It has been assumed that transponders were not evolved enough for the raw waste treatment. Especially of concern were the interferences of the transponder by electromagnetic influences.

DE 198 02 415 Al discloses a process for tracking the flow of waste by providing a material designation in a databank for every package which is generated at a collection side, writing the identification onto a machine-readable data-carrier, for example by printing a bar-code on a label, associating the identification with the material designation in a data bank, attaching a machine-readable data-carrier to every package, loading the package for shipping, transporting the package to a waste treatment location and, reading the data-carrier identification, namely the bar-code, at the waste treatment location and associating the data-carrier identification with the material designation in the data bank.

The present invention solves the problem of facilitation of the use of transponders for the documentation of waste manipulation whereby a complete documentation of waste logistics is achieved with little technical effort and whereby deceptive manipulation is eliminated.

The problem is solved with the method as described in patent claim 1. Accordingly, the packages for which waste has been collected are each fitted with a transponder. A transponder is an electronic data carrier that is prompted to answer a contactless transmission of electromagnetic interrogating signals with a modulated digital signal. Basically, different categories of transponders exist which include such transponders that receive an electric battery and an active electric circuit. The simplest transponders are passive transponders without their own energy source. Such transponders are equally suitable for the present invention. They respond to an interrogating signal with only an identification. The identification is a distinct signal that only refers to that particular transponder. All other transponders have different identifications. Such a transponder is firmly attached to the package with the method as described in patent claim 1.

The term package includes all forms of defined collected waste should it be a bale, a barrel, a drum or a bag. The manner in which the transponder is affixed to a package depends on the kind of package used.

In this manner the fact that waste, in particular plastics, is compressed into bales that are then held together with a wire can be taken advantage of.

The transponder can then, for example, be attached to the wire with a snap hook allowing it to be detached but leaving it securely attached. The problem of not being able to find the transponder is hereby solved. The transponder can be interrogated by leading the package past a reading station with a mobile hand-held reading device or past an automated reading station. The transponder would then reveal its identity. In the databank the transponder identification is allocated to the respective package. It calls for an address record that includes relevant data such as the material of the waste and the quality of the waste as well as the origin of the collection site. It is thus not only the transponder identity that is revealed from the transponder answer but also that of the package to which the transponder belongs. There is a reading of the transponder when the package is transported from one transportation location to another. In this manner the package can be traced until its arrival at the waste treatment location. In the databank that has been provided with the reader device information, the transportation route, or as the case may be, the current location of the package can be determined at any time. At the waste treatment location the treatment of the materials of each package is entered into the databank, which means that the circumstance of the package treatment is registered in the databank. As long as a package has not been treated it is still contained in the databank as existent along with all tracking and identification information. Only when the package has been treated will it be “de-registered” and only then will the processing plant, the carrier and, as the case may, be other businesses involved in the treatment process be credited.

The use in accordance with the present invention ensures that all parties involved have an interest in moving the packages with transponders to the waste treatment locations and to duly carry out and document the treatment since only when the treatment has been finally documented will an acknowledgement and the release of the required payments occur in the databank. All parties involved in the collection and transport of the packages always have an interest in duly delivering the package with the transponder to the waste treatment location. The unauthorized stripping or destruction of a transponder does not benefit the perpetrator.

The acknowledgement or, as the case may be, the de-registration of a package merely means that the handling of this package is recorded as being in good standing in the databank. It does not mean that the data pertaining to the composition and identification of the package as well as the transport route are deleted. Rather, the data is appropriately stored for a predetermined period of time so that any demand for information can be granted.

In accordance with a preferred further embodiment of the invention a provision has been provided for that allows for the creation of a lot list of the transponder that belongs to each transport lot during the collection of the package for the transport lots in the form of an “electronic bill of lading”. The transport lot is weighed after the packages have been collected and this value is also stored in the electronic bill of lading. In this manner every lot is documented on its own data carrier which is physically transported together with the transport lot. At the receiving location it is thus easy to establish if the package from the receiving site is still complete by reading each transponder and comparing the data to the lot list. The lot list can also be stored in the databank. This presumes that the central has operation access to the existing computers of each station on the transport route. At the waste treatment location the transponder of each of the packages already treated is de-registered from the lot list. The transponder is then invalidated and can be re-used for another transport.

In accordance with the concept of the present invention it is also ensured that the data capture, the data transfer and the data processing occur at locations that are not burdened with radiation from electric power lines and such.

Below, with reference to the only FIGURE in the drawing, an example of the implementation of the invention will be described in detail.

In the drawing, a schematic flow chart of the process in accordance with the invention is shown.

The waste 10 is sorted at a collection site 11 and kept ready, sorted according to type. Every waste type would, for example, contain a different plastic, such as PVC, polyethylene, polyurethane and so forth. There is a compression press 12 at the collection site in which waste of one kind is compressed into a package 13. The package 13 is in the present case a bale, which is held together with a tie. A transponder 14 is attached to the package 13. A Read-Only-Transponder is usually sufficient. The attachment of the transponder 14 occurs in accordance with the described implementation with a string 15, preferably a rubber string that facilitates the leading of the package to the reading device. The transponder 14 is a passive transponder that answers a contactless transmission of an electromagnetic interrogating signal with a modulated digital identification signal. This identification is a distinct signal that only refers to that particular transponder 14 and which is assigned once.

The package 13 fitted with a transponder 14 is led past a reading device 16. The reading device 16 activates the transponder 14 and receives its identification. The identification is sent to a computer 17 that receives other data. Such data include:

disposition number,

variety of waste,

weight of package,

identification of collection site,

quality of waste,

date/time,

personal information.

It would be possible to add other data. The computer 17 as well as all other computers associated with the process is connected to a central 18 via a fixed network or a mobile network in which a databank 19 is located. Another possibility would be that the local databanks of the processing establishments could be read-in/called from the central. In the databank 19 every transponder 14 is allocated the data belonging to the package 13.

After the passing of the reading device 16 the packages 13 are put into intermediate storage in a storage unit 20.

From the storage unit 20 the packages 13 are placed in a transport vehicle 21 whereby they are each combined into transport lots 22 comprised of, for example, 60 bales. Every transport lot of 60 bales forms a transport unit. At loading, the transponders attached to the packages are collected using a hand-held reading device. At the conclusion of the loading the net weight of the cargo as well as the average weight for each loaded bale is determined. Then the hand-held reading device is placed in a docking station that is connected to a computer and that transmits the data pertaining to the cargo to the PC. Similarly, the inventory stock is updated and an electronic bill of lading is generated. In the present example of an invention implementation, the data carrier 25 is an integrated circuit card with electronic storage that is recorded with the data of a transponder, which belongs to a transport lot. This “electronic bill of lading” contains, for example, the identification of the collection site, of the treating location and the mandate number as well as other data associated with the transport and the cargo.

The data carrier 25 with the transport list is brought with the transport vehicle 21. The transport vehicle moves the transport lot 22 to a waste treatment location 26.

At the waste treatment location 26 the waste treatment occurs, that could, for example, include granulation or melting. At the waste treatment location the packages 13 are opened.

At this point, the transponder 14 is read by a reading device 27. Another reading device 28 is added to the data carrier 25 with the lot list. The “electronic bill of lading” can once more be read using a mobile reading device. When all data for a transport have been collected, the reading device is adapted to a docking station. In this manner, the lot list is entered into the computer 29. Data contained in each transponder 14 is read by the reading device 28 and entered into the computer 29. The data is then compared to the lot list there so that each single transponder can be de-registered from the lot list. In this manner the data banks can be updated automatically at the sorter.

At the waste treatment location 26 it is determined that a package with a documented origin and transportation route has been treated. The confirmation of this fact is delivered at the databank 19. In the databank 19 the registration of the treated package occurs, including the collection site where the package was assembled and the transportation steps leading up to the treatment.

To ensure sufficient control and documentation of the people involved, the people in charge at the treatment location 26 or, as the case may be, also at the collection site 11, must enter their personal identification in the respective computer to prompt the computer to take the necessary steps. Unauthorized use can be avoided by using-secret passwords.

In the process according to the present invention the manufacturer of each package can be traced from the emergence of the package until its treatment. Furthermore, it can always be determined who the sender of a bale was and to whom the bale was to be sent. A bill and payment will only be possible if a package has duly arrived at the treatment location.

The process in accordance with the present invention also allows for the supervision of a treatment location. Since the number of treated packages and the weight are known, for example, a plausibility control can be carried out by examining the energy usage by the treatment location.

Differently than in the described implementation example of the present invention, it would also be possible to transfer all data that identifies the package 13 together with the lot list on the data carrier 25. In this case a connection between each of the computers 17,24,29 and the central 18 is not necessary. The data carrier 25 forms the databank that contains all the composition and transport data in the port at the waste treatment site, which are entered into the computer of the central 18.

The transfer possibilities are limitless, possibilities such as telecommunication, Intranets and the Internet could be used.

The characteristics of the invention revealed in the above description, in the drawing, as well as in the patent claims could be significant for the realization of the invention individually as well as in any combination.

1. A method for documenting and tracking waste packages comprising the steps of:
providing a material designation in a central databank (19) for every package (13) which is generated at a collection site,
attaching a machine-readable data carrier (14) to every package (13),
reading the identification of the data carrier (14) into the central databank (19),
associating the data carrier identification with the material designation in the central databank (19),
loading the package (13) for shipping,
transporting the packages (13) to a waste treatment location (26) and
reading the data carrier identification at the waste treatment location (26);
characterized by
associating information related to the waste treatment location (26) with the data carrier information and transferring both items of information to the central databank (19) and
wherein said data carrier (14) is a transponder.

2. The method according to claim 1, wherein the package (13) is transported in transport lot (22), a lot list being generated for all of the transponders (14) belonging to the transport lot (22), and wherein the transponders (14) belonging to the treated packages are de-registered from the lot list at the waste treatment location (26).

3. The method according to claim 2, wherein the weight of each transport lot (22) is determined and registered on the lot list.

4. The method according to claim 2, wherein the lot list is stored on a further data carrier (25) brought with the transport lot (22) and a reading device (28) reads the transponder identification from the data carrier at the waste treatment location (26).

5. The method according to one of the preceding claims wherein, in addition to the material designation, information related to the weight of the waste contained in the package (13) is stored in the databank (19).

6. The method according to one of the preceding claims wherein, in addition to the material designation, information related to the quality of the waste contained in the package (13) is stored in the databank (19).

7. The method according to one of the preceding claims, wherein the central databank (19) determines if the package (13) has been sent to an appropriate waste treatment location (26).

8. The method according to claims 2 to 7, wherein if the central databank (19) has determined that the package (13) has been sent to the appropriate waste treatment location (26), the central databank (19) authorizes the release of funds.

9. The method according to claim 7, wherein the central databank (19) registers the package (13) after it has received the transponder identification.

10. The method according to one of the preceeding claims, wherein the central databank (19) de-registers the package (13) after it has received the transponder identification from the transponder (14) and the material designation data from the databank (19) in the waste treatment location (26).
